(19) United States
(12) Patent Application Publication
(10) Pub. No.: US 2020/0267961 A1
(43) Pub. Date: Aug. 27, 2020

(54) Mobile Application for Bed Bug Detection

(71) Applicant: Brian Virag, Encino, CA (US)

(72) Inventor: Brian Virag, Encino, CA (US)

(21) Appl. No.: 16/404,652

(22) Filed: May 6, 2019

Related U.S. Application Data
(63) Continuation-in-part of application No. 16/281,089, filed on Feb. 21, 2019.

(51) Int. Cl. A01M 1/02; H04W 4/80; G06K 9/22

(52) U.S. Cl. CPC A01M 1/026; A01M 2200/011; G06K 9/22; H04W 4/80

(57) ABSTRACT

The present invention identifies bed bugs using a specially designed probing device paired with a mobile application designed to inspect the small, dark spaces of furnishings and accommodations where bed bugs may hide. The present invention captures an image of the inspected space with a camera, mirror and light component at the end of a probing unit, transmits the image wirelessly to a computing device for closer inspection or verification of the presence of a bed bug and transmits the information to a remote server.

### CROSS REFERENCE TO RELATED APPLICATION

This application claims priority to and is a continuation of U.S. patent application Ser. No. 16/281,089 entitled A Method and Device for Detecting Bed Bugs which was filed on Feb. 21, 2019, the contents of which are incorporated by reference herein.

### FIELD OF THE INVENTION

This invention relates to an insect detection and monitoring mobile application and device. This invention is particularly suited for detecting bed bugs.

### BACKGROUND

Cimex lectularius, or bed bugs as they are commonly known, are insects that feed on human blood and usually feed at night. Their bites can result in rashes, blisters or allergic reactions. These pests are highly undesirable and are hitchhiker insects that attach themselves to luggage and other belongings to move to new locations. Businesses, like hotels, go to great lengths to avoid the presence of bed bugs. If a hotel has a reputation for having bed bugs, business can be severely and negatively impacted.

Bed bugs are spread by being carried to new locations, typically on personal items like luggage. It is common for bed bugs to be found in hotels and other high-density areas. During the day, bed bugs hide in dark areas, like mattress seams and small cracks in nearby walls. Bed bugs feed at night and are attracted to their human hosts by body heat.

Infestations can grow rapidly. A single bed bug can result in 300 adults and 1,000 new eggs in as little as 3 months. Thus, it is imperative that the first signs of an infestation be identified so that extermination procedures can be promptly initiated.

To avoid a bed bug infestation, it is imperative to closely inspect sleeping accommodations and furniture for bed bugs prior to and following each use for signs of the pests.

It may be difficult to properly inspect the space around a mattress, headboard and box spring for bed bugs due to the small, dark nature of their preferred environment. Bed bugs hide in cracks and crevices to avoid detection.

Mature bed bugs are very similar in size and appearance to an apple seed or piece of lint. Young bed bugs are even smaller in size or lighter in color and are difficult to identify.

Bed bug detection is a tedious process that benefits from the experience of a seasoned examiner. However, consumers, especially consumers who frequently travel, would not generally characterize themselves as experienced bed bug examiners. They would, however, like to have peace of mind of knowing that the furnishings they are about use are free of insects and pests. Thus, consumers would benefit from the guidance and knowledge of an experienced bed bug examiner.

In addition, consumer standards are rising and patrons expect to be provided with clean and sanitary furnishing prior to use. Most consumers would like reassurance that their furnishings, have been examined for bed bugs and have passed inspection immediately prior to their use.

The present invention solves this problem.

### SUMMARY OF THE INVENTION

The present invention identifies bed bugs using a specially designed probing device designed to inspect small, dark spaces including the spaces surrounding a mattress, box spring, furniture, picture frames, night stands and other small, narrow cracks and crevices of a bed or room where bed bugs can be found. The present invention captures an image of the inspected space, with a camera at the end of a probing unit, and transmits the image to computing device for closer inspection and verification of the presence of a bed bug. The device is designed to function in connection with a mobile application or software application for guiding inspection, reporting of incidents and searching for incidents of infestation in the surrounding area.

In one embodiment of the present invention, the mobile application is paired to the inspecting apparatus, referred to as a wand, for guided inspection, capturing images of a bed bug infestation and reporting the incident for recording on a database of infested locations and furnishings, the database is housed on a remote server.

In one embodiment of the present invention, a camera is positioned at the end of a probe, for example an endoscope. The camera is utilized to capture images of bed bugs that infest the inspected bedding. The camera is equipped with a light and mirror feature for capturing clear images for transmission by the endoscope to a computing device, for example a smart phone. Captured images can be used to confirm the presence of a bed bug infestation. The apparatus is collectively referred to as a wand. The wand is connected to a mobile application that guides detection, captures images, records incidents of infestation, and/or maintains a database of locations where an infestation exists or existed in the past.

The present invention also discloses a method of using the described device for inspecting bedding for bed bugs.

### BRIEF DESCRIPTION OF DRAWINGS

FIG. 1 discloses a diagram of a system, according to an example embodiment.

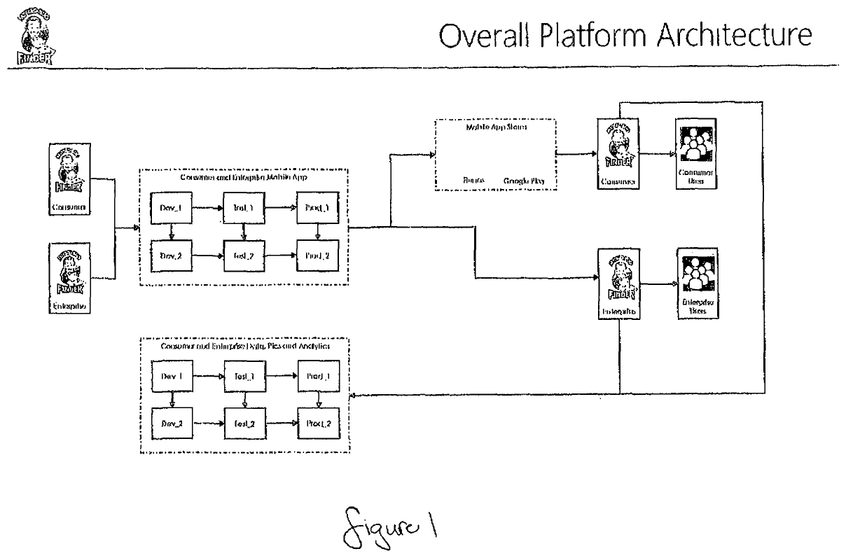

FIG. 2 discloses a flow diagram of a method, according to an example embodiment.

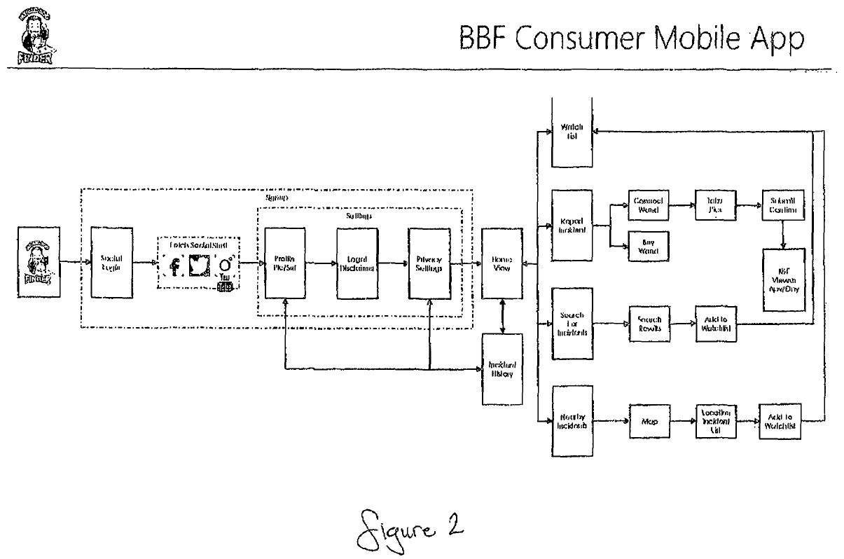

FIG. 3 discloses a flow diagram of a method, according to an example embodiment.

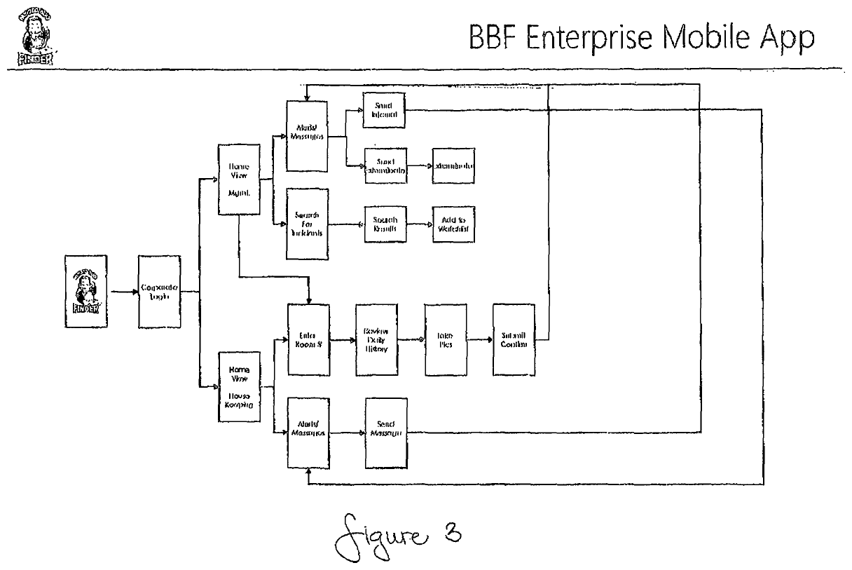

### DETAILED DESCRIPTION OF THE INVENTION

As used herein, the words or terms used herein have the following definitions:

A bed bug is a member of the Cimex lectularius species of insects that feed on human blood. It is a wingless hemipterous bug that is known to infest human dwellings.

An endoscope is an illuminated, ridged tubular instrument for inspection of bed bugs in a specified area.

A computing device is a smart phone, tablet, PC or other device that can receive image transmissions from a camera for inspection of bed bugs in a specified area.

A camera is a device that consists of a lightproof chamber with an aperture fitted with a lens and a shutter through which the image of an object is projected onto a surface for recording or for translation into electrical impulses.

A mirror is a polished, smooth surface that forms images by reflection.

A shark fin is a removable attachment for placement at the camera end of the present invention. It is designed to capture images on the mirror component of the invention for reflection onto the camera component of the invention so that images are not too far from or close to the camera and clear images may be captured. A light component allows the image to be viewed on the mirror component and reflected on to the camera component.

An examiner is the person using the disclosed invention.

A wand is the apparatus used for inspection.

In one embodiment of the present invention, the device comprises an endoscope for capturing images of bed bugs in an inspected space. In another embodiment of the present invention, the device further comprises a light component that is used to illuminate dark spaces for better inspection. In a preferred embodiment, the light is an LED light.

In another embodiment of the present invention, the device further comprises a mirror component. The mirror component is used to reflect images from an inspected surface for capture by the camera component.

In another embodiment of the present invention, the mirror and/or light components of the device may comprise a removable “shark fin” component. The shark fin component attaches to the camera end of the endoscope for capturing clear images of a bed bug in an inspected space. The image is captured at the optimal distance from the camera lens for viewing and transmission.

The endoscope includes a telescoping feature, which allows the user to access spaces that are difficult to reach by the examiner. For example, it may be difficult for an examiner to crawl under a bed to inspect the middle of a box spring. Using the telescoping feature of the present invention, the camera end of the endoscope can reach the middle of a box spring for inspection and images of the space can be captured by the camera for transmission to a computing device.

The endoscope may also be used in a retracted position for inspection of small spaces near the examiner.

Images captured by the camera are transmitted to a receiving device. A smart phone is a device commonly used by consumers; it is a preferred embodiment of the present invention that the computing device be a smart phone.

It is contemplated that a receiving device can be a smart phone, a tablet, a computer or other device that can be used to receive images transmitted by the camera.

In one embodiment of the present invention, bed bugs are detected using sensors designed to detect the presence of a bed bug, in lieu of visual confirmation of the presence of an infestation. Types of sensors include, but are not limited to, sniffer, thermal and light sensors. A sniffer, or olfactory sensor, detects the presence of aldehyde pheromones. Bed bugs emit aldehyde pheromones, thus where this pheromone is present, it is an indication that an infestation exists. A thermal, or heat signature detector, sensor detects the presence of heat emitted by bed bugs. Thus, where a thermal sensor detects the presence of body heat, it is an indication that bed bugs are present in the inspected area, despite the lack of visual confirmation. A light sensor, or photo sensor, can also be used to detect evidence of a bed bug infestation. A light sensor can include infrared or ultraviolet wavelengths sensors.

The present invention also discloses a method for detecting bed bugs using the apparatus disclosed herein. In one embodiment of the present invention, the endoscope is connected to a smartphone using a wireless connection, a process known by those of ordinary skill in the art. The smartphone contains a mobile application that allows an examiner to connect a wand to the mobile application, another process known by those of ordinary skill in the art. The mobile application may be either an end user version that is designed for use directly by consumers, as well as an enterprise version that is designed for use by hotels to ensure cleanliness of rooms prior to each use by hotel guests.

The mobile device is connected to a remote server, which stores and transmits data, using a wireless network, a process known by those of ordinary skill in the art. A wireless network includes a cellular network or a WiFi network. The process of which is evident to a person of ordinary skill in the art.

The mobile application allows a user to purchase a wand for bed bug inspection directly through the application.

The application also allows the examiner to easily connect the wand to the computing device. An examiner simply clicks on the “connect” link to attach a wand to the computing device.

The mobile application may guide the examiner on an effective strategy for inspecting furnishing prior to use. For example, the mobile application may direct the examiner to begin an inspection by examining the top of the bed, under the sheets, between the mattress and the box spring, under the box spring, in front of the headboard, behind the headboard, adjacent furniture and adjacent walls.

The mobile application may then guide the examiner in capturing images of an infestation. For example the mobile application may notify the user when an image is unclear and how the examiner can capture clearer images of an infestation. Once images are captured, the examiner may submit the image and report an incident onto the application database.

In the consumer version of the mobile application, a database consisting of locations and furnishings with known and suspected bed bug infestations is maintained to warn perspective guests about known infestations. The user may conduct a search based on the user's geo location or latitude and longitude coordinates. The database allows users to search for locations with a history of infestation as well as locations currently experiencing infestations. The database also maintains a list of locations that are suspected of infestations on a separate list. A user may also designate a particular location, for example a frequently used hotel, as a watch list location. When a location that is identified on a user's watch list is flagged as a site where an infestation is discovered, the user will be notified.

In the enterprise version, specific rooms or furnishings with known infestations may be quarantined using the mobile application to prevent use of the room by hotel guests.

The enterprise version allows a member of an organization, like a business, to send and receive alerts and messages related to an infestation to other members of an organization. In response to an infestation, a business's management may send an internal report to document the incident. Management may also contact an exterminator to eliminate the infestation.

The enterprise version also has a setting for use by inspection staff, for example, housekeeping staff for inspecting a room or furnishing, capturing images of an infestation or lack thereof, and alerting or messaging management of the presence of an infestation.

In another embodiment of the present invention, a software program or mobile application on the computing device is used to guide inspection, instruct the examiner, capture images, save images, and/or transmit images to another device.

In one embodiment of the present invention, where an infestation is discovered, a user is provided with a list of exterminators or a preferred exterminator to contain and eradicate the infestation. The user may contact the pest control provider and arrange for extermination services.

It is contemplated that the present invention may be used to inspect hotels, motels, Air BnBs, apartments, cruise ships, airplanes, schools, day care, theaters, spas, camps, storage facilities, hospitals, medical offices, urgent care facilities, convalescent homes, hospice care, retirement homes and communities, work places, homeless shelters, women shelters, health clubs, second hand stores, retail furniture both used and new, colleges, dormitories, libraries, court houses, government buildings, public transportation, busses, trains, ferry's, rental cars, furniture rental and amusement parks. This list is meant to illustrate examples of places the present invention is designed to inspect, it is not an exhaustive list of all locations that could be inspected by the present invention.

1. A mobile device comprising:
a memory, and
a processor configured for:
pairing with an apparatus for inspecting for bed bugs, the apparatus comprising an endoscope, with a computing device;
capturing images of bed bug infestations; and
transmitting images of infestations to a remote server, and
storing data related to locations with bed bug infestations.

2. The mobile device disclosed in claim 1, further comprising a processor for guiding bed bug inspection.

3. The mobile device disclosed in claim 1, further comprising a processor for transmitting data related to locations with infestations.

4. The mobile device disclosed in claim 1, further comprising transmitting messages related to an infestation between computing devices.

5. A method comprising:
downloading a mobile application onto a mobile device;
linking the mobile device to a wand for bed bug inspection; and
inspecting a space for the presence of a bed bug.

6. The method disclosed in claim 5, further comprising capturing images of a bed bug.

7. The method disclosed in claim 5, further comprising transmitting an image of a bed bug to a remote server.

8. The method disclosed in claim 5, further comprising transmitting messages related to an infestation to a remote server or computing device.

9. The method disclosed in claim 5, further comprising purchasing a bed bug inspection wand.

10. The method disclosed in claim 5, further comprising contacting an exterminator to contain an infestation.

11. A method comprising:
downloading a mobile application onto a mobile device; and
searching for locations with beg bug infestations.
